(19) United States
(12) Patent Application Publication
(10) Pub. No.: US 2023/0381042 A1
(43) Pub. Date: Nov. 30, 2023

(54) SYSTEM AND METHOD FOR CONTROLLING AIR TEMPERATURE IN AN INCUBATOR

(71) Applicant: GE Precision Healthcare LLC, Milwaukee, WI (US)

(72) Inventors: Steven M. Falk, Baltimore, MD (US); Karen P. Becker, Baltimore, MD (US)

(73) Assignee: GE Precision Healthcare LLC, Milwaukee, WI (US)

(21) Appl. No.: 17/825,694

(22) Filed: May 26, 2022

(51) Int. Cl. A61G 11/00

(52) U.S. Cl. CPC A61G 11/00; A61G 2203/46; A61G 2203/10

(57) ABSTRACT

An incubator includes a sensor configured to measure a temperature of a baby. The incubator also includes a temperature control device configured to modify a temperature of an environment. The incubator also includes a computing system configured to obtain a first desired environmental temperature (DET) for the baby. The computing system is also configured to obtain a DET zone for the baby based at least partially upon the first DET. The computing system is also configured to control the temperature of the environment with the temperature control device during a first period time based at least partially upon the first DET, the DET zone, or both. The computing system is also configured to compare a second DET to the first DET, the DET zone, or both. The computing system is also configured to trigger an alarm in response to the comparison.

### BACKGROUND

A neonatal intensive care unit (NICU), also known as an intensive care nursery (ICN), is an intensive care unit (ICU) specializing in the care of ill or premature newborn infants. Neonatal refers to the first 28 days of life. Oftentimes, in the NICU, a newborn infant will be placed in an incubator. An incubator is an apparatus used to maintain environmental conditions suitable for the infant. The incubator may provide oxygenation, through oxygen supplementation by head hood or nasal cannula, positive airway pressure (CPAP), or mechanical ventilation.

Infant respiratory distress syndrome is the leading cause of death in preterm infants, and the main treatments include CPAP, in addition to administering pulmonary surfactant and stabilizing the blood sugar, blood salts, and blood pressure. The incubator may also aid with observation of the infant. More particularly, the incubator may provide sophisticated measurement of temperature, respiration, cardiac function, oxygenation, and brain activity. The incubator may also provide protection from cold temperature, infection, noise, drafts, and excess handling. For example, incubators may be described as bassinets enclosed in plastic, with climate control equipment designed to keep babies warm and limit their exposure to germs. The incubator may also provide nutrition, through an intravenous catheter or nasogastric (NG) tube. The incubator may also facilitate administration of medications. For example, the incubator may help to maintain fluid balance by providing fluid and keeping a high air humidity to prevent too great a loss from skin and respiratory evaporation.

### SUMMARY

Aspects of the disclosure include an incubator. The incubator may include a bed configured to receive a baby. The incubator may also include a canopy positioned at least partially over the bed. The bed and the canopy define an environment around the baby. The incubator may also include a sensor configured to measure a temperature of the baby. The incubator may also include a temperature control device configured to modify a temperature of the environment. The incubator may also include a computing system configured to obtain a first desired environmental temperature (DET) for the baby. The computing system is also configured to obtain a DET zone for the baby based at least partially upon the first DET. The computing system is also configured to control the temperature of the environment with the temperature control device during a first period time based at least partially upon the first DET, the DET zone, or both. The computing system is also configured to calculate a second DET for the baby after the temperature of the environment has been controlled during the first period of time. The computing system is also configured to compare the second DET to the first DET, the DET zone, or both. The computing system is also configured to trigger an alarm in response to the comparison.

The first DET is based at least partially upon a gestational age of the baby, a number of days of life of the baby, a weight of the baby, a health of the baby, or a combination thereof.

The DET zone includes an upper temperature threshold and a lower temperature threshold. The first DET is defined between the upper and lower temperature thresholds.

The second DET is based at least partially upon the temperature of the baby measured after the temperature of the environment has been controlled during the first period of time.

The computing system is further configured to control the temperature of the environment with the temperature control device during a second period of time based at least partially upon the second DET.

The alarm is triggered in response to the second DET being outside of the DET zone.

The alarm is triggered in response to the second DET being outside of the DET zone for more than a predetermined amount of time or by more than a predetermined temperature.

The alarm is triggered in response to a slope of the second DET deviating from a slope of the first DET by more than a predetermined amount.

The alarm is triggered before the second DET exits the DET zone.

The alarm is triggered in response to a slope of the second DET being greater than a first predetermined slope or less than a second predetermined slope.

In another embodiment, the incubator may include a bed configured to receive a baby. The incubator may also include a canopy positioned at least partially over the bed. The bed and the canopy define an environment around the baby. The incubator may also include a first sensor configured to measure a temperature of the baby. The incubator may also include a second sensor configured to measure a temperature of the environment. The incubator may also include a temperature control device configured to modify the temperature of the environment. The incubator may also include a computing system configured to receive or calculate a first desired environmental temperature (DET) for the baby based at least partially upon a gestational age of the baby, a number of days of life of the baby, a weight of the baby, and a health of the baby, wherein the first DET decreases over time. The computing system is also configured to receive or calculate a DET zone for the baby based at least partially upon the first DET. The DET zone includes an upper temperature threshold and a lower temperature threshold. The first DET is defined between the upper and lower temperature thresholds. The computing system is also configured to control the temperature of the environment with the temperature control device during a first period of time based at least partially upon the first DET, the DET zone, or both. The computing system is also configured to calculate a second DET for the baby after the temperature of the environment has been controlled during the first period of time. The second DET is based at least partially upon the temperature of the baby measured after the temperature of the environment has been controlled during the first period of time. The computing system is also configured to control the temperature of the environment with the temperature control device during a second period of time based at least partially upon the second DET. The computing system is also configured to compare the second DET to the first DET, the DET zone, or both. The computing system is also configured to detect an event in response to the comparison. The computing system is also configured to trigger an alarm in response to the event.

A method is also disclosed. The method may include receiving or calculating a first desired environmental temperature (DET) for a baby in an incubator. The method may also include receiving or calculating a DET zone for the baby based at least partially upon the first DET. The DET zone includes an upper temperature threshold and a lower temperature threshold. The first DET is defined between the upper and lower temperature thresholds. The method may also include controlling a temperature of an environment in the incubator during a first period of time based at least partially upon the first DET, the DET zone, or both. The method may also include measuring a temperature of the baby after the temperature of the environment has been controlled during the first period of time. The method may also include calculating a second DET for the baby after the temperature of the environment has been controlled during the first period of time. The second DET is based at least partially upon the temperature of the baby measured after the temperature of the environment has been controlled during the first period of time. The method may also include controlling the temperature of the environment during a second period of time based at least partially upon the second DET. The method may also include comparing the second DET to the first DET, the DET zone, or both. The method may also include detecting an event in response to the comparison. The method may also include triggering an alarm in response to the event.

### BRIEF DESCRIPTION OF THE DRAWINGS

The present disclosure may best be understood by referring to the following description and accompanying drawings that are used to illustrate examples of the invention. In the drawings:

FIG. 1 illustrates a schematic view of an incubator, according to an example.

FIG. 2 illustrates a perspective view of the incubator, according to an example.

FIG. 3 illustrates a graph showing a patient temperature (PT) and a first desired environmental temperature (DET), according to an example.

FIG. 4 illustrates the graph showing a DET zone around the first DET, according to an example.

FIG. 5 illustrates a graph showing a second DET increasing and no longer within the DET zone, according to an example.

FIG. 6 illustrates a flowchart of a method for determining the DET, according to an example.

FIG. 7 illustrates a flowchart of a method for controlling the incubator, according to an example.

FIG. 8 illustrates a schematic view of data from the incubator (and a plurality of other incubators) being used to train a machine learning (ML) algorithm, according to an example.

FIG. 9 illustrates a flowchart of another method for controlling the incubator, according to an example.

FIG. 10 illustrates a schematic view of a computing system for performing at least a portion of one or more of the methods described herein, in accordance with some examples.

### DETAILED DESCRIPTION

The following disclosure describes several examples for implementing different features, structures, or functions of the invention. Examples of components, arrangements, and configurations are described below to simplify the present disclosure; however, these examples are provided merely as examples and are not intended to limit the scope of the invention. Additionally, the present disclosure may repeat reference characters (e.g., numerals) and/or letters in the various examples and across the Figures provided herein. This repetition is for the purpose of simplicity and clarity and does not in itself dictate a relationship between the various examples and/or configurations discussed in the Figures. Moreover, the formation of a first feature over or on a second feature in the description that follows may include examples in which the first and second features are formed in direct contact, and may also include examples in which additional features may be formed interposing the first and second features, such that the first and second features may not be in direct contact. Finally, the examples presented below may be combined in any combination of ways, e.g., any element from one exemplary example may be used in any other exemplary example, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various examples of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

| Element | Reference Number |
|---|---|
| Incubator | 100 |
| Other incubators | 101-103 |
| Bed | 110 |
| Baby | 115 |
| Canopy | 120 |
| Patient temperature sensor | 130A |
| Environment temperature sensor | 130B |
| Temperature control device | 140 |
| Computing system | 150 |
| Display | 160 |
| Alarm | 170 |
| Graph | 300 |
| Patient temperature | 310 |
| First DET | 320 |
| DET zone | 330 |
| Upper threshold | 340 |
| Lower threshold | 350 |
| Second DET | 360 |
| First time segment | 372 |
| Second time segment | 374 |
| Third time segment | 376 |
| Graph | 400 |
| Graph | 500 |
| Flowchart | 600 |
| Flowchart | 700 |
| Machine learning algorithm | 800 |
| Flowchart | 900 |
| Computing system | 1000 |
| Computer systems | 1001A-D |
| Analysis module | 1002 |
| Processor(s) | 1004 |
| Storage media | 1006 |
| Network interface | 1007 |
| Incubator control module | 1008 |
| Network | 1009 |

The present disclosure may provide one or more of a variety of different technical advantages. For example, the disclosure provides an incubator that monitors and controls the air temperature therein. When the incubator is in “baby” mode, the air temperature may be controlled based at least partially upon the temperature of the baby (also referred to as newborn or infant) and the baby's temperature change. In one embodiment, the air temperature may follow a slowly decreasing trend over time (also referred to as desired environmental temperature or DET), which reflects the growth and maturity development of the baby. In other words, as the baby grows and becomes more mature and healthier, the baby may be able to better regulate his/her own internal temperature and thus may require less heat from the air in the incubator. However, if the air temperature in the incubator varies by more than a predetermined amount from this slowly decreasing trend, the incubator may trigger an alarm, which may call the caregiver back to the incubator. The caregiver may be or include a doctor, a nurse, or another medical professional. Such a variation (e.g., increase) in air temperature may be due to the health status of the baby decompensating or the temperature sensor dislodging from the baby.

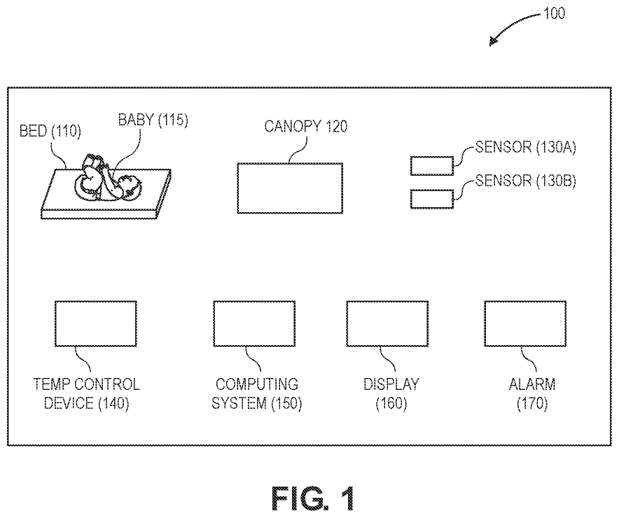

FIG. 1 illustrates a schematic view of an incubator 100, according to an example. The incubator 100 may include a bed 110 configured to receive a baby 115. The incubator 100 may also include a canopy 120 positioned at least partially around and/or over the bed 110. The canopy 120 may be made of a transparent material (e.g., acrylic). The bed 110 and the canopy 120 may define an environment in which the baby 115 may be positioned.

The incubator 100 may also include one or more sensors (two are shown: 130A, 130B). The sensor 130A may be or include a patient temperature (PT) sensor that is configured to be attached to the baby 115 and to measure the temperature of the baby 115. The sensor 130B may be or include an environmental temperature (ET) sensor that is configured to measure the temperature of the environment (e.g., air) in the incubator 100.

The incubator 100 may also include a temperature control device 140. The temperature control device 140 may be configured to vary the temperature inside the internal volume. In one example, the temperature control device 140 may be or include a heater that is configured to introduce heated air into the internal volume. In another example, the temperature control device 140 may be or include a cooler (e.g., air conditioner) that is configured to introduce cooled air into the internal volume.

The incubator 100 may also include a computing system 150. The computing system 150 may be configured to receive the data from the sensor(s) 130A, 130B and to control the temperature control device 140 based at least partially upon the data. More particularly, the incubator 100 (e.g., the temperature control device 140 and/or the computing system 150) may include two or more thermal regulation modes. In the first (e.g., manual) mode, the temperature of the environment may be controlled (e.g., set at a predetermined value) that is independent of the temperature of the baby 115. In the second (e.g., baby) mode, the temperature of the environment may be controlled based at least partially upon the temperature of the baby 115.

The incubator 100 may also include one or more displays (one is shown: 160). The display 160 may be configured to display information to a caregiver (e.g., doctor, nurse, etc.) and/or the parent(s). The information may be or include vital signs of the baby 115 such as the patient temperature (PT), heart rate, blood pressure, etc. The information may also or instead be or include the temperature of the environment, a desired environmental temperature (DET, described below) in the environment, or the like.

The incubator 100 may also include an alarm 170. The computing system 150 may be configured to trigger the alarm 170 in response to the temperature of the baby 115 being greater than or less than a predetermined patient temperature range, the environmental temperature being greater than or less than an environmental temperature range, the desired environmental temperature being greater than or less than a desired environmental temperature range, the heart rate being greater than or less than a predetermined HR range, the blood pressure being greater than or less than a predetermined BP range, or the like. The alarm 170 may be audible, visible, or both. Additional details about the incubator 100 are provided below.

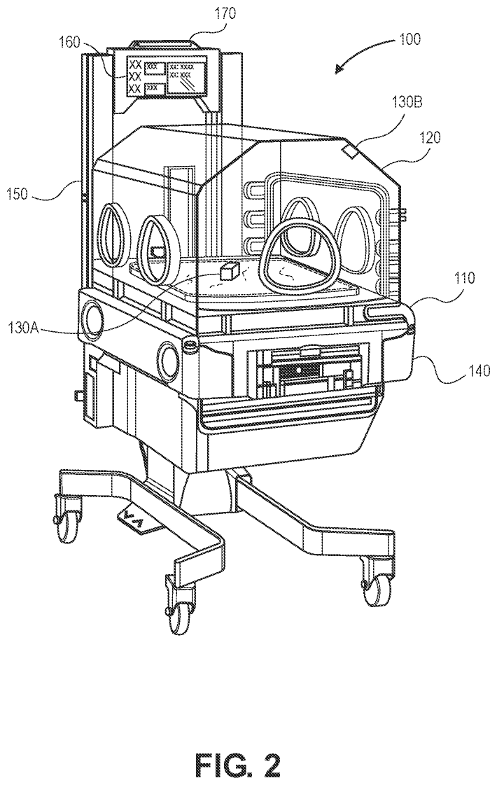

FIG. 2 illustrates a perspective view of the incubator 100, according to an example. The incubator 100 may include the bed 110, the canopy 120, the sensors 130A, 130B, the temperature control device 140, the computing system 150, the display 160, the alarm 170, or a combination thereof. In one example, the incubator 100 may be or include a Giraffe™ Carestation™ manufactured by GE Healthcare. The incubator 100 may provide a neurodevelopmentally supportive, family-centered critical care environment for newborns.

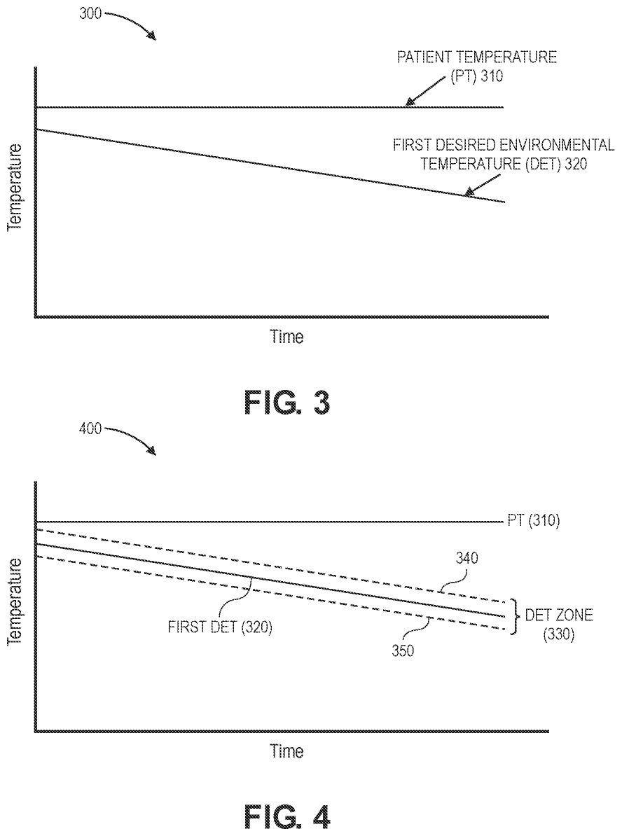

FIG. 3 illustrates a graph 300 showing a patient temperature (PT) 310 and a first (also referred to as initial or planned) desired environmental temperature (DET) 320, according to an example. The patient temperature 310 may be the temperature of the baby 115 in the incubator 100. As mentioned above, the patient (e.g., baby 115) temperature 310 may be measured by the sensor 130A. Through a combination of the baby 115 thermoregulating his/her own temperature, and the temperature in the incubator 100 (e.g., which may be varied by the temperature control device 140), the patient temperature 310 may be maintained at a substantially constant temperature (e.g., 37 degrees Celsius).

The first desired environmental temperature 320 may be determined based at least partially upon the gestational age of the baby 115 (e.g., time inside the mother), the number of days of life of the baby 115 (e.g., outside of the mother), the weight of the baby 115, the health of the baby 115 (e.g., including any particular illnesses), the temperature of the baby 115, or a combination thereof. The first desired environmental temperature 320 may be the same as, or different from, the actual temperature of the environment inside the incubator 110 that is measured by the sensor 130B.

As mentioned above and shown in FIG. 3, first desired environmental temperature 320 may follow a slowly decreasing trend over time, which reflects the growth and maturity development of the baby 115. In other words, as the baby 115 grows and becomes more mature and healthier, the baby 115 may be able to better thermoregulate his/her own internal temperature and thus require less temperature help from the incubator 100 (e.g., the temperature control device 140).

FIG. 4 illustrates the graph 400 showing a desired environmental temperature (DET) zone 330 around the first desired environmental temperature 320, according to an example. The desired environmental temperature zone 330 may be based at least partially upon the first desired environmental temperature 320.

The desired environmental temperature zone 330 may include a first (e.g., upper) temperature threshold 340 and a second (e.g., lower) temperature threshold 350 with the first desired environmental temperature 320 therebetween. The desired environmental temperature zone 330 may include a range that is from about 1 degree Celsius to about 10 degrees Celsius, about 1 degree Celsius to about 8 degrees Celsius, about 1 degree Celsius to about 6 degrees Celsius, about 1 degree Celsius to about 4 degrees Celsius, or about 0.5 degrees Celsius to about 2 degrees Celsius, among others.

In one embodiment, the upper and lower temperature thresholds 340, 350 may be substantially equally spaced from the first desired environmental temperature 320. For example, the upper temperature threshold 340 may be 1 degree Celsius greater than the first desired environmental temperature 320, and the lower temperature threshold 350 may be 1 degree Celsius less than the first desired environmental temperature 320. In another embodiment, the upper and lower temperature thresholds 340, 350 may be spaced differently from the first desired environmental temperature 320. For example, the upper temperature threshold 340 may be 1 degree Celsius greater than the first desired environmental temperature 320, and the lower temperature threshold 350 may be 2 degrees Celsius less than the first desired environmental temperature 320.

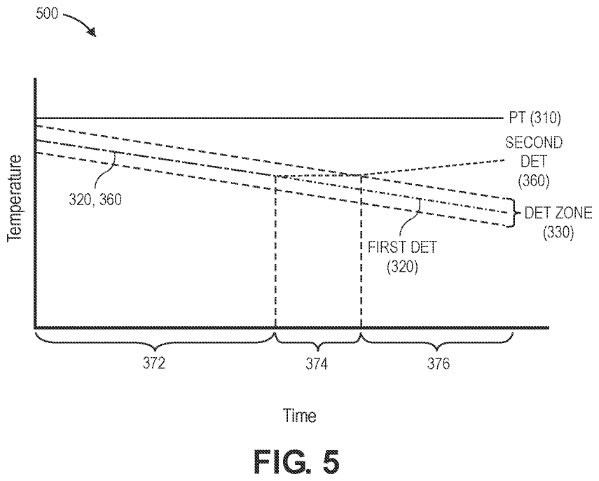

FIG. 5 illustrates a graph 500 showing a second (also referred to as modified or actual) desired environmental temperature 360 deviating from the first desired environmental temperature 320 such that it increases and is no longer within the desired environmental temperature zone 330, according to an example. As described in greater detail below, the desired environmental temperature may be determined at a plurality of different times while the baby 115 is in the incubator 100. For example, the desired environmental temperature may be recalculated every 10 minutes. While only two (e.g., first and second) desired environmental temperatures are described herein, it will be appreciated that tens, hundreds, or thousands of desired environmental temperatures may be calculated for the baby 115 while the baby 115 is in the incubator 100.

The second desired environmental temperature 360 may be determined or calculated based at least partially upon the first desired environmental temperature 320, the patient temperature 310, a patient control temperature, or a combination thereof, as described below. The patient control temperature refers to the skin set temperature that the caregiver sets (e.g., the desired patient skin temperature). The second desired environmental temperature 360 may also or instead be determined or calculated based at least partially upon the gestational age of the baby 115, the number of days of life of the baby 115, the weight of the baby 115, the health of the baby 115, or a combination thereof.

As shown in FIG. 5, for a first time segment 372, the second desired environmental temperature 360 may track the first desired environmental temperature 320. More particularly, both the first desired environmental temperature 320 and the second desired environmental temperature 360 may gradually decrease and remain within the desired environmental temperature zone 330. Then, for a second time segment 374, the second desired environmental temperature 360 may deviate from the first desired environmental temperature 320 but still remain within the desired environmental temperature zone 330. In this example, the second desired environmental temperature 360 may become greater than the desired environmental temperature 320. Then, for a third time segment 376, the second desired environmental temperature 360 may continue deviating from the first desired environmental temperature 320 and exit the desired environmental temperature zone 330. In this example, the second desired environmental temperature 360 may become greater than the upper temperature threshold 340 of the desired environmental temperature zone 330.

Although this particular example shows the second desired environmental temperature 360 becoming greater than the first desired environmental temperature 320 and the upper temperature threshold 340 of the desired environmental temperature zone 330, in another embodiment, the second desired environmental temperature 360 may become less than the first desired environmental temperature 320 and the lower temperature threshold 350 of the desired environmental temperature zone 330. As mentioned above, the second desired environmental temperature 360 deviating from the first desired environmental temperature 320 and/or exiting the desired environmental temperature zone 330 may be due to the health status of the baby 115 decompensating or the temperature sensor 130A dislodging from the baby 115.

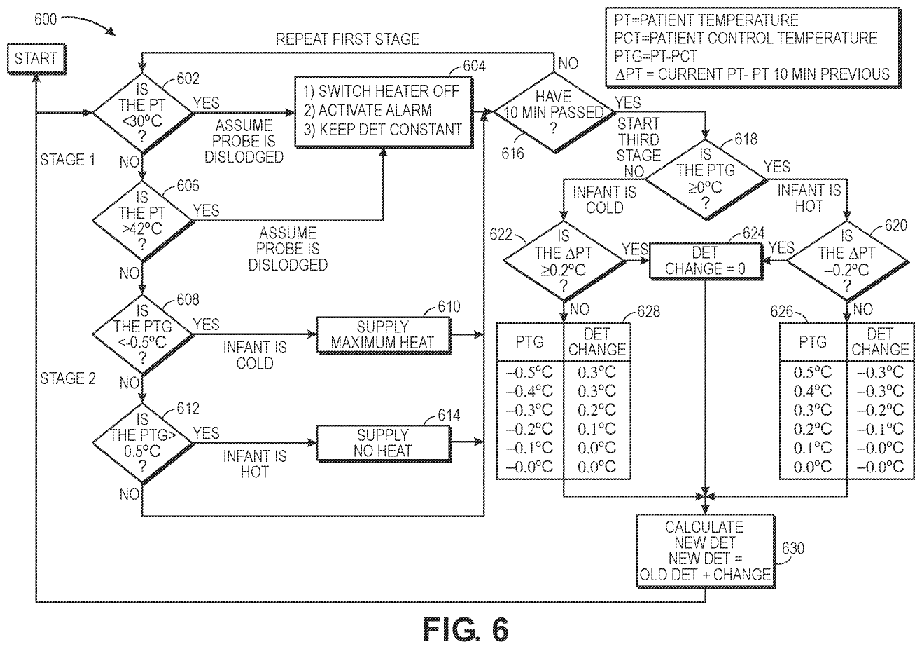

FIG. 6 illustrates a flowchart of a method 600 for calculating and recalculating the desired environmental temperature to yield the first desired environmental temperature 320, the second desired environmental temperature 360, and so on, according to an example. An illustrative order of the method 600 is provided below; however, one or more steps of the method 600 may be performed in a different order, combined, split into sub-steps, repeated, or omitted. One or more steps of the method 600 may be performed using the computing system 150.

The method 600 may include determining whether the patient temperature 310 is less than a first patient temperature threshold, as at 602. The first patient temperature threshold may be, for example, 30 degrees Celsius.

If the patient temperature 310 is less than the first patient temperature threshold, it may be assumed that the sensor 130A is dislodged from the baby 115, and the method 600 may include switching the temperature control device (e.g., heater) 140 off, activating the alarm 170, maintaining the desired environmental temperature 320, or a combination thereof, as at 604.

If the patient temperature 310 is not less than the first patient temperature threshold, the method 600 may include determining whether the patient temperature 310 is greater than a second patient temperature threshold, as at 606. The second patient temperature threshold may be greater than the first patient temperature threshold. The second patient temperature threshold may be, for example, 42 degrees Celsius.

If the patient temperature 310 is greater than the second patient temperature threshold, it may be assumed that the sensor 130A is dislodged from the baby 115, and the method 600 may include switching the temperature control device (e.g., heater) 140 off, activating the alarm 170, maintaining the desired environmental temperature 320, or a combination thereof, as at 604.

If the patient temperature 310 is between the first and second patient temperature thresholds, the method 600 may include determining whether a difference between the patient temperature and the patient control temperature (e.g., PT−PCT) is less than a first PTG threshold, as at 608. The first PTG threshold may be, for example −0.5 degrees Celsius.

If the difference is less than the first PTG threshold, it may be determined that the baby 115 is cold, and the method 600 may include supplying (e.g., maximum) heat using the temperature control device (e.g., heater) 140, as at 610.

If the difference is not less than the first PTG threshold, the method 600 may include determining whether the difference between the patient temperature and the patient control temperature (e.g., PT−PCT) is greater than a second PTG threshold, as at 612. The second PTG threshold may be greater than the first PTG threshold. The second PTG threshold may be, for example, 0.5 degrees Celsius.

If the difference is greater than the second PTG threshold, it may be determined that the baby 115 is hot, and the method 600 may include supplying less (e.g., no) heat using the temperature control device (e.g., heater) 140, as at 614. Alternatively, the temperature control device 140 may supply cool air into the environment.

After step 604, 610, and/or 614, the method 600 may include determining whether a predetermined amount of time has passed, as at 616. The predetermined amount of time may be, for example, 10 minutes.

If the predetermined amount of time has not passed, the method 600 may loop back to step 602. If the predetermined amount of time has passed, the method 600 may include determining whether the difference between the patient temperature and the patient control temperature (e.g., PT−PCT) is greater or equal to than a third PTG threshold, as at 618. The third PTG threshold may be between the first and second PTG thresholds. The third PTG threshold may be, for example, 0 degrees Celsius.

If the difference is greater than or equal to the third PTG threshold, it may be determined that the baby 115 is hot, and the method 600 may include determining whether a change in patient temperature is less than or equal to a first temperature change, as at 620. The first temperature change may be, for example, −0.2 degrees Celsius.

If the difference is not greater than or equal to the third PTG threshold, it may be determined that the baby 115 is cold, and the method 600 may include determining whether the change in patient temperature is greater than or equal to a second temperature change, as at 622. The second temperature change may be, for example, 0.2 degrees Celsius.

If the answer to step 620 and/or 622 is “yes,” the method 600 may include maintaining the desired environmental temperature 320, as at 624. In other words, the desired environmental temperature remains the same (e.g., is not changed).

If the answer to step 620 is “no,” the method 600 may include determining a decrease in the desired environmental temperature, as at 626. The amount that the desired environmental temperature is decreased may be based at least partially upon the difference between the patient temperature and the patient control temperature (e.g., PT−PCT).

If the answer to step 620 is “yes,” the method 600 may include determining an increase the desired environmental temperature, as at 628. The amount that the desired environmental temperature is increased may be based at least partially upon the difference between the patient temperature and the patient control temperature (e.g., PT−PCT).

After step 624, 626, and/or 628, the method 600 may include determining and implementing the new desired environmental temperature, as at 630. The new desired environmental temperature may be the old desired environmental temperature plus the change calculated at step 624, 626, and/or 628. The new desired environmental temperature may be implemented by the temperature control device 140 and/or the computing system 150.

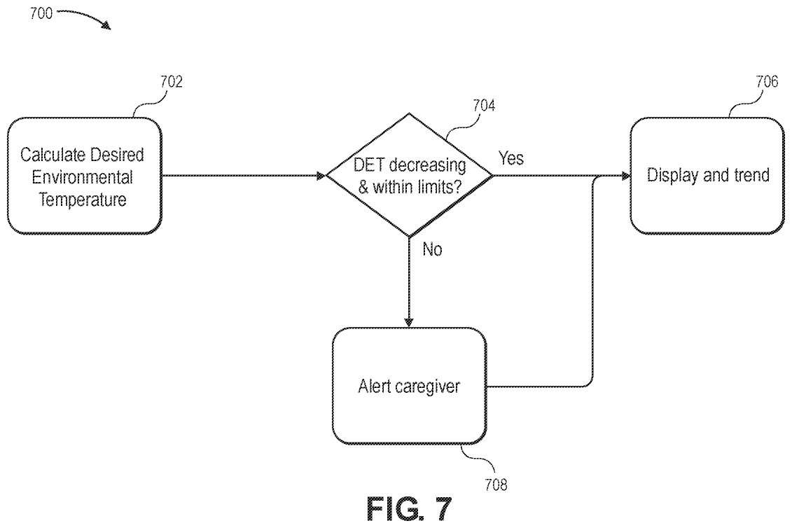

FIG. 7 illustrates a flowchart of a method 700 for controlling the incubator 100, according to an example. An illustrative order of the method 700 is provided below; however, one or more steps of the method 700 may be performed in a different order, combined, split into sub-steps, repeated, or omitted. One or more steps of the method 700 may be performed using the computing system 150.

The method 700 may include calculating (and/or re-calculating) the desired environmental temperature, as at 702. This may include calculating the first desired environmental temperature 320, the second desired environmental temperature 360, and so on. An example of this is described above with respect to FIG. 6.

The method 700 may also include determining whether the environmental temperature is (e.g., remaining) within the desired environmental temperature zone 330, as at 704. This may include determining whether the second desired environmental temperature 360 is decreasing and remaining within the desired environmental temperature zone 330 over time. As mentioned above, the desired environmental temperature zone 330 may be based at least partially upon the first desired environmental temperature 320.

If the second desired environmental temperature 360 is within the desired environmental temperature zone 330, the method 700 may include displaying the temperature data, as at 706. This may include displaying the patient temperature 310, the first desired environmental temperature 320, the desired environmental temperature zone 330, the second desired environmental temperature 360, or a combination thereof on the display 160.

However, if the second desired environmental temperature 360 is not within the desired environmental temperature zone 330, the method 700 may include triggering the alarm 170, as at 708. For example, if the second desired environmental temperature 360 exceeds the upper temperature threshold 340, as shown in FIG. 5, the alarm 170 may be triggered to call the caregiver to check on the baby 115. In one embodiment, the alarm 170 may be triggered if the second desired environmental temperature 360 exits the desired environmental temperature zone 330 for more than a predetermined amount of time. The predetermined amount of time may be greater than 1 second, greater than 10 seconds, greater than 30 seconds, greater than 1 minute, greater than 5 minutes, or greater than 10 minutes. In another embodiment, the alarm 170 may be triggered if the second desired environmental temperature 360 deviates from the desired environmental temperature zone 330 by more than a predetermined amount. The predetermined amount may be 0.1 degree Celsius, 0.5 degrees Celsius, 1 degree Celsius, or 2 degrees Celsius.

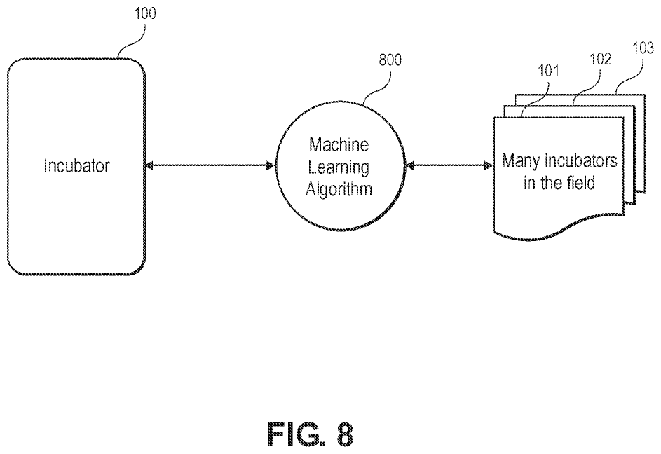

FIG. 8 illustrates a schematic view of data from the incubator 100 (and a plurality of other incubators 101-103) being used to train a machine learning (ML) algorithm 800, according to an example. The data measured by the incubator(s) 100-103 may be transmitted to the ML algorithm 800, which may be running on the computing system 150 of the incubator 100 or a central computing system 1000 (described below).

The data may be or include the gestational age of the baby 115, the number of days of life of the baby 115, the weight of the baby 115, the health of the baby 115, the temperature of the baby 310, the first desired environmental temperature 320 for the baby 115, the desired environmental temperature zone 330 for the baby 115, the second desired environmental temperature 360 for the baby 115, the measured temperature of the environment, or a combination thereof. The data may be used to train (or calibrate) the ML algorithm 800.

In one embodiment, the trained ML algorithm 800 may be configured to modify the first desired environmental temperature 320 for the baby 115, the desired environmental temperature zone 330 for the baby 115, the second desired environmental temperature 360 for the baby 115, or a combination thereof. This modification may occur at predetermined intervals (e.g., once per day). In another embodiment, the trained ML algorithm 800 may be configured to determine the desired environmental temperature for a new baby and/or the desired environmental temperature zone for the new baby.

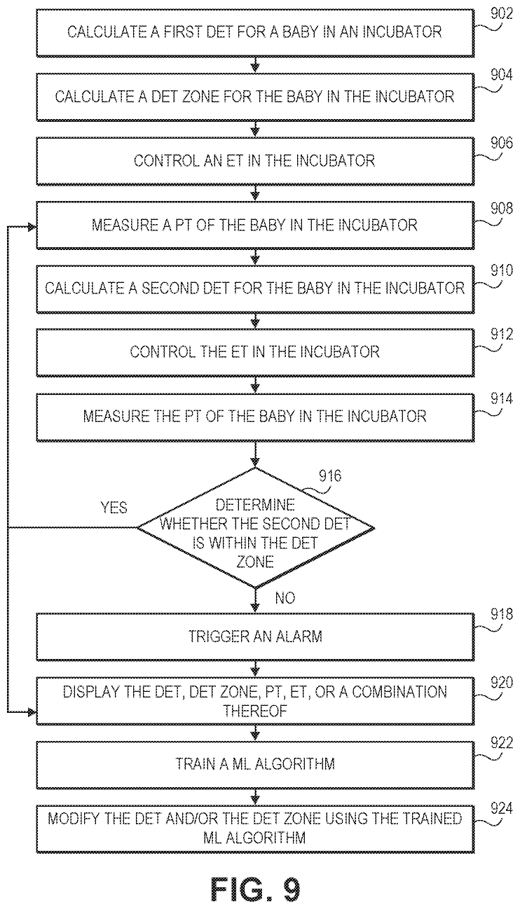

FIG. 9 illustrates a flowchart of another method 900 for controlling the incubator 100, according to an example. An illustrative order of the method 900 is provided below; however, one or more steps of the method 900 may be performed in a different order, combined, split into sub-steps, repeated, or omitted. One or more steps of the method 900 may be performed using the computing system 150.

The method 900 may include receiving or calculating a desired environmental temperature for a baby 115 in an incubator 100, as at 902. This may be the first desired environmental temperature 320. As mentioned above, the first desired environmental temperature 320 may be calculated based at least partially upon the gestational age of the baby 115, the number of days of life of the baby 115, the weight of the baby 115, the health of the baby 115, the temperature of the baby 115, or a combination thereof. An example of this is described above with respect to FIG. 6.

The method 900 may also include receiving or calculating a desired environmental temperature zone 330 for the baby 115 in the incubator 100, as at 904. The desired environmental temperature zone 330 may be calculated based at least partially upon the first desired environmental temperature 320. The desired environmental temperature zone 330 may also or instead be calculated based at least partially upon the gestational age of the baby 115, the number of days of life of the baby 115, the weight of the baby 115, the health of the baby 115, the temperature of the baby 115, or a combination thereof. As shown in FIG. 5, both the first desired environmental temperature 320 and the desired environmental temperature zone 330 may gradually decrease over time.

The method 900 may also include controlling the environmental temperature (a first time), as at 906. The environmental temperature may be controlled using the temperature control device 140 and/or the computing system 150. More particularly, the computing system 150 may control the temperature control device 140 to maintain or modify the environmental temperature. The environmental temperature may be controlled based at least partially upon the measured patient temperature 310 (e.g., when the incubator 100 is operating in baby mode), the first desired environmental temperature 320, the desired environmental temperature zone 330, or a combination thereof.

The method 900 may also include measuring a patient temperature 310 of the baby 115 in the incubator 100, as at 908. The patient temperature 310 may be measured with the sensor 130A before or after the environmental temperature is controlled the first time. This step may also or instead include measuring an environmental temperature inside the incubator 100. The environmental temperature may be measured with the sensor 130B before or after the environmental temperature is controlled the first time.

The method 900 may include calculating the desired environmental temperature for the baby 115 in the incubator 100 (a second time), as at 910. This may be the second desired environmental temperature 360. The second desired environmental temperature 360 may be calculated based at least partially upon the patient temperature 310 (e.g., measured after temperature of the environment is controlled the first time), the first desired environmental temperature 320, the measured environmental temperature, the patient control temperature, the gestational age of the baby 115, the number of days of life of the baby 115, the weight of the baby 115, the health of the baby 115, the temperature of the baby 115, or a combination thereof.

The method 900 may also include controlling the environmental temperature (a second time), as at 912. The environmental temperature may be controlled using the temperature control device 140 and/or the computing system 150. More particularly, the computing system 150 may control the temperature control device 140 to maintain or modify the environmental temperature. The environmental temperature may be controlled the second time based at least partially upon the measured patient temperature 310, the first desired environmental temperature 320, the desired environmental temperature zone 330, the second desired environmental temperature 360, or a combination thereof.

The method 900 may also include measuring a patient temperature 310 of the baby 115 in the incubator 100 (a second time), as at 914. The patient temperature 310 may be measured after the environmental temperature is controlled the second time. This step may also or instead include measuring an environmental temperature inside the incubator 100 (a second time).

The method 900 may also include comparing the second desired environmental temperature 360 to the first desired environmental temperature 320, the desired environmental temperature zone 330, or both, as at 916. This may include determining whether the second desired environmental temperature 360 is within (or outside of) the desired environmental temperature zone 330. For example, the second desired environmental temperature 360 measured at a first minute may be compared to the desired environmental temperature zone 330 determined at the first minute, the second desired environmental temperature 360 measured at a second minute may be compared to the desired environmental temperature zone 330 determined at the second minute, and so on.

In one embodiment, this step may also or instead include determining whether a slope of the second desired environmental temperature 360 deviates from a slope of the first desired environmental temperature 320 by more than a predetermined amount. This may allow the method 900 to detect a problem (e.g., health status of the baby 115 decompensating or the temperature sensor 130A dislodging from the baby 115) before the second desired environmental temperature 360 exits the desired environmental temperature zone 330. This may be illustrated by referring back to the example shown in FIG. 5. There, the slope of the first desired environmental temperature 320 and the second desired environmental temperature 360 are both the same within the first time segment 372. The slope of the first desired environmental temperature 320 is the same in the second time segment 374 as it is in the first time segment 372. However, the slope of the second desired environmental temperature 360 is different in the second time segment 374 than it is in the first time segment 372. Thus, determining whether a slope of the second desired environmental temperature 360 deviates from a slope of the first desired environmental temperature 320 by more than a predetermined amount may allow the method 900 to detect a problem in the second time segment 374, before the second desired environmental temperature 360 exits the desired environmental temperature zone 330.

In another embodiment, this step may also or instead include determining whether the slope of the second desired environmental temperature 360 is greater than a first predetermined slope or less than a second predetermined slope. In an example, the first predetermined slope may be zero.

In response to the second desired environmental temperature 360 being within the desired environmental temperature zone 330 (or the slope of the second desired environmental temperature 360 deviating from the first desired environmental temperature 320 by less than the predetermined amount), the method 900 may loop back around to step 908 for another iteration at a subsequent time, and/or continue to step 920.

However, in response to an event being detected (e.g., in response to the comparison), the method 900 may also include triggering an alarm 170, as at 918. The alarm 170 may call the caregiver to the incubator 100 to determine whether the health status of the baby 115 is decompensating or the sensor 130A has dislodged from the baby 115. In an example, the event may be or include the second desired environmental temperature 360 being outside of the desired environmental temperature zone 330 (or the slope of the environmental temperature 360 deviating from the desired environmental temperature 320 by more than the predetermined amount).

The method 900 may also include displaying the patient temperature 310, the first desired environmental temperature 320, the desired environmental temperature zone 330, the second environmental temperature 360, the measured environmental temperature, or a combination thereof, as at 920. The temperature(s) may be shown on the display 160. In an example, the temperature(s) may be shown in graphical form, as in FIGS. 3-5.

The method 900 may also include training a ML algorithm 800, as at 922. The ML algorithm 800 may be trained (or calibrated) using data received from the incubator 100 and/or a plurality of other incubators 101-103. The data may be or include the gestational age of the baby 115, the number of days of life of the baby 115, the weight of the baby 115, the health of the baby 115, the first desired environmental temperature (from 902), the desired environmental temperature zone 320 (from 904), the measured temperature of the baby 310 (from 908), the measured environmental temperature (from 908), the second desired environmental temperature 360 (from 910), or a combination thereof.

The method 900 may also include modifying the desired environmental temperature for the baby 115 and/or the desired environmental temperature zone 330 for the baby 115 using the trained ML algorithm 800, as at 924. This step may also or instead include determining a desired environmental temperature and/or a desired environmental temperature zone for a new baby.

In some examples, the method 900 can be implemented by any suitable infant care station such as an incubator, a warmer, or an infant care station that is configured to provide at least one feature of an incubator and a warmer.

Other Incubator Features

Cold stress and/or heat stress may have serious consequences for newborns. In small-for-gestational-age and preterm infants (e.g., <2500 g), these consequences may be devastating and may increase mortality rates. As such, infants need to maintain specific thermal control (e.g., their core body temperature) within a narrow range. For both healthy and medically challenged babies, careful attention may be paid to the thermal environment from the moment of birth to the time they are capable of temperature regulation.

The incubator described herein may provide thermoregulation. More particularly, the incubator may include a comfort zone to provide thermal guidance for setting and activating the desired temperature. The incubator may also provide clinical trends to assist the caregiver in reviewing thermoregulation data for detection of early signs of sepsis. The incubator may also provide uninterrupted uniform heat during the transition from incubator to warmer. The incubator may also provide an air boost to improve open-door thermal performance. The incubator may also provide a cascade control algorithm designed to minimize baby's temperature swings. The incubator may also provide heated internal components during open bed mode to support transition to closed bed mode. The incubator may also provide a radiant heater placed inside the canopy and shielded when in incubator mode. The incubator may also provide a warm-up mode default setting at 100% for rapid preparation of the bed. The incubator may also provide a preheat mode default setting (e.g., at 25%), with silenced alarms, for admission preparation. The incubator may also provide a servo humidity system for added thermal support and skin protection designed with universal precautions and sterility in mind to protect against infection. The incubator may also provide an in-bed scale to reduce time out of the heated environment. The incubator may also provide alarms to allow quick alerts to maintain desired thermal environment. The incubator may also provide a double wall construction with actively heated inner walls. The incubator may also provide skin temperature monitoring on or off the bed.

Exposure to excessive handling in neonatal ICUs may have an adverse impact on neurodevelopment in medically challenged newborns. While some types of touch are needed and/or may be beneficial to the infant, most handling is considered stressful. Evidence suggests even routine procedures can cause physiological instability, and excessive handling may exacerbate acute pain responses. Stressful touches may be minimized by reducing the need to move or reposition the baby for required procedures.

The incubator described herein may help to minimize negative touches. More particularly, the incubator may provide a one-touch canopy lift and foot pedal that converts the incubator into a radiant warmer without disturbing the baby due to bed-to-bed transfer. The incubator may also provide a bi-directional mattress that brings the baby closer to promote swaddling, and to assist in rotating the mattress for clinical procedures. The incubator may also provide a mattress with full 360° rotation for procedural ease. The incubator may also provide a pressure-diffusing mattress to support skin management and pressure redistribution. The incubator may also permit x-rays to be taken without moving the baby. The incubator may also provide a hands-free alarm silence allowing the caregiver to quickly silence the alarms while providing care inside the canopy with universal precautions. The incubator may also provide a smooth and continuous tilt minimizing stimulation to the baby. The incubator may also provide an in-bed scale with reweigh functionality to reduce transfers in and out of the bed.

Responses to loud noises (e.g., >80 dB) in the NICU have been linked to physiological response (hypoxemia) in infants. In addition, exposure to noise and other environmental factors in the NICU may disrupt the normal growth and development of medically challenged (and preterm) infants. The guidelines for NICU acoustical design outline the suggested sound levels for equipment, voice, and background noises.

The incubator described herein may be able to manage sound and promote normal growth and development. More particularly, the incubator may provide an alarm speaker placed low, beneath the body of the bed. The incubator may also provide an adjustable alarm volume to maximize alert while minimizing sound. The alarms may be disabled during pre-heat mode. The alarm defaults may be designed to minimize nuisance alarms during transitions. The alarm may provide a hands-free silence function that allows the caregiver to quickly silence the alarm while providing care inside the canopy and maintaining a quiet environment. The incubator may also provide a low noise fan to reduce noise levels within the bed. The incubator may also provide a hood cover to dampen external noise.

Evidence suggests that light levels should be dimmed for at least part of the day for some infants, to facilitate diurnal cycle development in mature infants. Continuous bright light has been related to infant stress, indicated by increased activity levels, decreased sleep, and bradycardia. Cycled light has the potential to promote circadian rhythm, with benefits that include hormonal regulation, activity-rest cyclicity and vital sign regulation. Light reduction is optimal in reducing stress, retinal protection and promoting sleep.

The incubator described herein may help manage light and stress. The incubator may provide a visual device indicator placed out of baby's field of vision. The incubator may also provide an exam light that is adjustable for appropriate lighting. The incubator may also provide a hood cover to minimize impact of overhead lighting, even in open mode, with flexible viewing arrangements. The incubator may also provide a screen brightness control with selectable, low, medium, and high viewing.

The incubator described herein may also provide family-centered developmental support. More particularly, the incubator may have an adjustable height to accommodate seated access for the parents. The incubator may also include a pass-through drawer that allows parents seated access even in a wheelchair. The incubator may also include a family-centric away screen and themes that allow parents and family members to understand their babies' care status. The incubator may also include a view display with high visibility to patient data and alarms. The incubator may also include side panels that can be completely removed to aid in transition to parent for skin-to-skin contact. The incubator may also include a bi-directional translating mattress to bring the baby closer and promote swaddling for skin-to-skin contact. The incubator may also include an air boost to improve open-door thermal performance with friendly reminders/prompts to activate. The incubator may also include an air mode and manual mode to maintain bed temperature while baby is held. The incubator may also include skin temperature monitoring ability during skin-to-skin contact.

In one or more examples, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

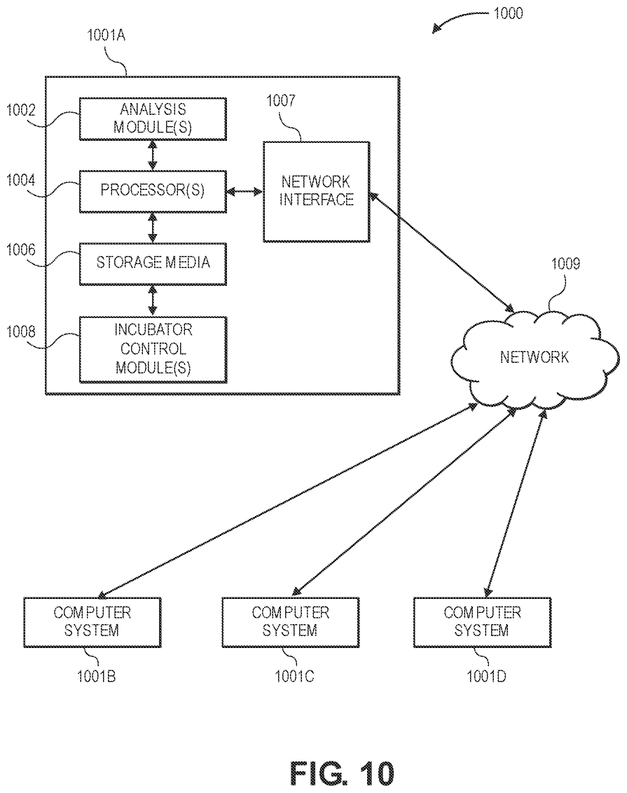

In some examples, any of the methods of the present disclosure may be executed by a computing system. FIG. 10 illustrates an example of such a computing system 1000, in accordance with some examples. The computing system 1000 may include a computer or computer system 1001A, which may be an individual computer system 1001A or an arrangement of distributed computer systems. The computer system 1001A includes one or more analysis module(s) 1002 configured to perform various tasks according to some examples, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor can include a microprocessor, microcontroller, processor module or subsystem, programmable integrated circuit, programmable gate array, or another control or computing device.

The storage media 1006 can be implemented as one or more computer-readable or machine-readable storage media. Note that while in the example of FIG. 10 storage media 1006 is depicted as within computer system 1001A, in some examples, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), B LURAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some examples, computing system 1000 contains one or more incubator control module(s) 1008. In the example of computing system 1000, computer system 1001A includes the incubator control module 1008. In some examples, a single incubator control module may be used to perform some or all aspects of one or more examples of the methods. In alternate examples, a plurality of incubator control modules may be used to perform some or all aspects of methods.

It should be appreciated that computing system 1000 is only one example of a computing system, and that computing system 1000 may have more or fewer components than shown, may combine additional components not depicted in the example of FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

The foregoing has outlined features of several examples so that those skilled in the art may better understand the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An incubator, comprising:
a bed configured to receive a baby;
a canopy positioned at least partially over the bed, wherein the bed and the canopy define an environment around the baby;
a sensor configured to measure a temperature of the baby;
a temperature control device configured to modify a temperature of the environment; and
a computing system configured to:
obtain a first desired environmental temperature (DET) for the baby;
obtain a DET zone for the baby based at least partially upon the first DET;
control the temperature of the environment with the temperature control device during a first period time based at least partially upon the first DET, the DET zone, or both;
calculate a second DET for the baby after the temperature of the environment has been controlled during the first period of time;
compare the second DET to the first DET, the DET zone, or both; and
trigger an alarm in response to the comparison.

2. The incubator of claim 1, wherein the first DET is based at least partially upon a gestational age of the baby, a number of days of life of the baby, a weight of the baby, a health of the baby, or a combination thereof.

3. The incubator of claim 1, wherein the DET zone comprises an upper temperature threshold and a lower temperature threshold, the first DET being defined between the upper and lower temperature thresholds.

4. The incubator of claim 1, wherein the second DET is based at least partially upon the temperature of the baby measured after the temperature of the environment has been controlled during the first period of time.

5. The incubator of claim 1, wherein the computing system is further configured to control the temperature of the environment with the temperature control device during a second period of time based at least partially upon the second DET.

6. The incubator of claim 1, wherein the alarm is triggered in response to the second DET being outside of the DET zone.

7. The incubator of claim 1, wherein the alarm is triggered in response to the second DET being outside of the DET zone for more than a predetermined amount of time or by more than a predetermined temperature.

8. The incubator of claim 1, wherein the alarm is triggered in response to a slope of the second DET deviating from a slope of the first DET by more than a predetermined amount.

9. The incubator of claim 8, wherein the alarm is triggered before the second DET exits the DET zone.

10. The incubator of claim 1, wherein the alarm is triggered in response to a slope of the second DET being greater than a first predetermined slope or less than a second predetermined slope.

11. An incubator, comprising:
a bed configured to receive a baby;
a canopy positioned at least partially over the bed, wherein the bed and the canopy define an environment around the baby;
a first sensor configured to measure a temperature of the baby;
a second sensor configured to measure a temperature of the environment;
a temperature control device configured to modify the temperature of the environment; and
a computing system configured to:
receive or calculate a first desired environmental temperature (DET) for the baby based at least partially upon a gestational age of the baby, a number of days of life of the baby, a weight of the baby, and a health of the baby, wherein the first DET decreases over time;
receive or calculate a DET zone for the baby based at least partially upon the first DET, wherein the DET zone comprises an upper temperature threshold and a lower temperature threshold, the first DET being defined between the upper and lower temperature thresholds;
control the temperature of the environment with the temperature control device during a first period of time based at least partially upon the first DET, the DET zone, or both;
calculate a second DET for the baby after the temperature of the environment has been controlled during the first period of time, wherein the second DET is based at least partially upon the temperature of the baby measured after the temperature of the environment has been controlled during the first period of time;
control the temperature of the environment with the temperature control device during a second period of time based at least partially upon the second DET;
compare the second DET to the first DET, the DET zone, or both;
detect an event in response to the comparison; and
trigger an alarm in response to the event.

12. The incubator of claim 11, wherein the event comprises the second DET being outside of the DET zone.

13. The incubator of claim 11, wherein the event comprises the second DET being outside of the DET zone for more than a predetermined amount of time or by more than a predetermined temperature.

14. The incubator of claim 11, wherein the event comprises a slope of the second DET deviating from a slope of the first DET by more than a predetermined amount.

15. The incubator of claim 14, wherein the alarm is triggered before the second DET exits the DET zone.

16. A method, comprising:
receiving or calculating a first desired environmental temperature (DET) for a baby in an incubator;
receiving or calculating a DET zone for the baby based at least partially upon the first DET, wherein the DET zone comprises an upper temperature threshold and a lower temperature threshold, the first DET being defined between the upper and lower temperature thresholds;
controlling a temperature of an environment in the incubator during a first period of time based at least partially upon the first DET, the DET zone, or both;
measuring a temperature of the baby after the temperature of the environment has been controlled during the first period of time;
calculating a second DET for the baby after the temperature of the environment has been controlled during the first period of time, wherein the second DET is based at least partially upon the temperature of the baby measured after the temperature of the environment has been controlled during the first period of time;
controlling the temperature of the environment during a second period of time based at least partially upon the second DET;
comparing the second DET to the first DET, the DET zone, or both;
detecting an event in response to the comparison; and
triggering an alarm in response to the event.

17. The method of claim 16, wherein the event comprises the second DET being outside of the DET zone.

18. The method of claim 16, further comprising instructing a user to determine whether a health status of the baby is decompensating or a sensor has dislodged from the baby in response to the alarm being triggered, wherein the sensor measures the temperature of the baby.

19. The method of claim 16, further comprising training a machine learning algorithm based at least partially upon the DET zone for the baby.

20. The method of claim 19, further comprising calculating a DET zone for a second baby using the trained machine learning algorithm.
